(19) United States
(12) Patent Application Publication
(10) Pub. No.: US 2010/0326798 A1
(43) Pub. Date: Dec. 30, 2010

(54) CLEATED CONVEYOR BELT

(76) Inventor: Henry Friesen, Winkler (CA)

Correspondence Address: ADE & COMPANY INC., 2157 Henderson Highway, WINNIPEG, MB, R2G1P9, CA

(21) Appl. No.: 12/757,618

(22) Filed: Apr. 9, 2010

Related U.S. Application Data
(60) Provisional application No. 61/221,884, filed on Jun. 30, 2009.

(51) Int. Cl. B65G 15/62

(52) U.S. Cl. 198/823

(57) ABSTRACT

A belt conveyor includes a belt which is in a flat configuration for a part of its path and in a transversely curved or semi-circular configuration in a part of its path through a guide tube. The belt has a plurality of paddle members arranged together in longitudinally spaced positions to act as cleats for restricting back flow under gravity of the particulate material in the tube. The paddle members are arranged so that two paddle members of a front row define between them a space which is sufficient to allow the paddle members to lie side by side and to avoid contact when moved into the curved configuration and a third paddle member is positioned behind the space between the two paddle members of the front row to prevent flow or material between the front two paddle members from moving rearwardly beyond the third paddle member.

This application claims priority under 35 U.S.C. 119 from Provisional Application 61/221,884 filed Jun. 30, 2009.

The present invention relates to conveyor belts and, more particularly, to conveyor belts having cleats which are arranged to allow the belt to run in a flat condition and also to take up a part cylindrical configuration by flexing of the belt as the belt passes through a conveyor tube.

### BACKGROUND OF THE INVENTION

In the prior art many arrangements of conveyor are provided where a conveyor belt moves along part of its length in flat form and a part of its length in an inclined tube and has cleats adaptable for transporting material through the inclined tube. It is known that some materials such as grain, ash or foundry dust are best moved by a conveyor equipped with a cleated belt. Even with a cleated belt, however, such material is susceptible to shifting due to gravity and vibration, and from blowing air while in transit along the conveyor belt.

Over the years, several attempts have been made to address the problem. Most commonly, the solution is to enclose the conveyor belt within a tube. This approach generally requires the use of an un-cleated belt since traditional cleats will not appropriately conform to the tube circumference. Therefore, while solving the blowing air concerns, this solution does not address the problem of back sliding due to gravity.

An example of a conveyor of this general type is shown in U.S. Pat. No. 6,170,646 (Kaeb) issued Jan. 9, 2001. Cleats are attached at spaced positions along the length of the belt and extend perpendicular to the surface of the belt. The cleats disclosed by Kaeb are provided with either notches or slits. As the flat conveyor belt is directed through the tube, both the conveyor belt and cleats adapt to the shape of the tube. The notches or slits of the cleat enable it to form a solid cleat wall, thereby, preventing materials from slipping back on the conveyor belt during movement of the conveyor belt upwardly through the inclined tube.

A similar arrangement is also shown in French patent no: 1358636 (Baujon) assigned to Veuve G. Boinet of France and published Mar. 9, 1964 which shows a cleat on a belt where the cleat is formed from a series of separate sections arranged in a row across the belt and the sections are arranged with side edges which converge upwardly and inwardly to form notches between the sections. In this way, when the side edges are brought together by curving the belt in a part cylindrical configuration, the side edges butt to form a closed cleat.

Another similar arrangement is shown in U.S. Pat. No. 6,405,855 (Petier) issued Jun. 18, 2002.

### SUMMARY OF THE INVENTION

It is one object of the invention to provide a conveyor belts having cleats which are arranged to allow the belt to run in a flat condition and also to take up a part cylindrical configuration.

According to one aspect of the invention there is provided a conveyor comprising:

an endless belt arranged to travel from a first end of a conveyor path to a second end of the conveyor path;

a guide construction for the belt arranged such that the belt lies in a substantially flat configuration in a transverse plane for a part of its path and lies in a transversely curved configuration in another part of its path;

the guide construction including a duct through which the belt passes while in its curved configuration;

a drive arrangement for driving the belt along the path;

the belt having an upper surface for carrying a particulate material thereon so that the upper surface is concave in the curved configuration;

and a plurality of paddle members mounted on and projecting upwardly from the upper surface for restricting back flow under gravity of the particulate material on the upper surface;

the paddle members being arranged to cooperate in an arrangement where two paddle members of a front row define between them a space which is sufficient to allow the paddle members to lie side by side and to avoid contact when moved into the curved configuration and a third paddle member is positioned behind the space between the two paddle members of the front row with a width of the third paddle member which cooperates with the distance between the front paddle members and the third paddle to prevent flow or material between the front two paddle members from moving rearwardly beyond the third paddle member.

Preferably the two paddle members are arranged in a front row containing a plurality of paddle members.

Preferably the third paddle member is arranged in a rear row containing a plurality of paddle members.

Preferably the rows are spaced longitudinally of the belt and the paddle members of each row are arranged such that adjacent paddle members of the row are spaced longitudinally of the belt by a distance so as to avoid contact between the adjacent paddles members of the row in either the flat configuration or the curved configuration.

Preferably the distance between the paddle members of the front row is such that the particulate material is inhibited from back flowing between the paddle members of the rear row under gravity at least in the curved configuration.

Preferably the paddle members have a height of at least 1.0 inches.

Preferably the paddle members have a height of at least 1.5 inches.

Preferably the paddle members have a height of at least 2.0 inches.

Preferably the paddle members which are closest to side edges of the belt are spaced inwardly from the side edges.

Preferably the paddle members are arranged in a row which contains at least three paddle members.

Preferably the paddle members are arranged in two rows with one row containing one more paddle member than the other row.

Preferably one row contains four paddle members and the other row contains three paddle members.

Preferably the longitudinal spacing between the two paddle members of the first row and the third paddle member is at least 1 inch and preferably at least 2 inches.

Preferably the two paddle members and the third paddle member form a first group and a longitudinal spacing between the first group and a next adjacent group is at least 6 inches and preferably at least 9 inches.

Preferably each paddle member comprises a substantially flat plate which stands outwardly from the upper surface of the belt.

Preferably each paddle member is substantially at right angles to the upper surface of the belt.

Preferably each paddle member includes a base attached to the upper surface and curves inwardly and upwardly to the paddle members.

### BRIEF DESCRIPTION OF THE DRAWINGS

One embodiment of the invention will now be described in conjunction with the accompanying drawings in which:

FIG. 1 is an isometric view of a conveyor of the type with which the present invention is concerned.

FIG. 2 is an isometric view of the lower feed end of the conveyor of FIG. 1 showing the arrangement of the belt and the cleats on the belt as it moves from an initial flat condition at the inlet to a curved condition in the tube.

FIG. 3 is an isometric view of a portion of the belt of the conveyor of FIG. 1 showing the cleats on the belt in flat condition.

FIG. 4 is a side elevational view of the portion of the belt of the conveyor showing the cleats on the belt in flat condition.

FIG. 5 is a rear elevational view of the portion of the belt of the conveyor showing the cleats on the belt in flat condition.

In the drawings like characters of reference indicate corresponding parts in the different figures.

### DETAILED DESCRIPTION

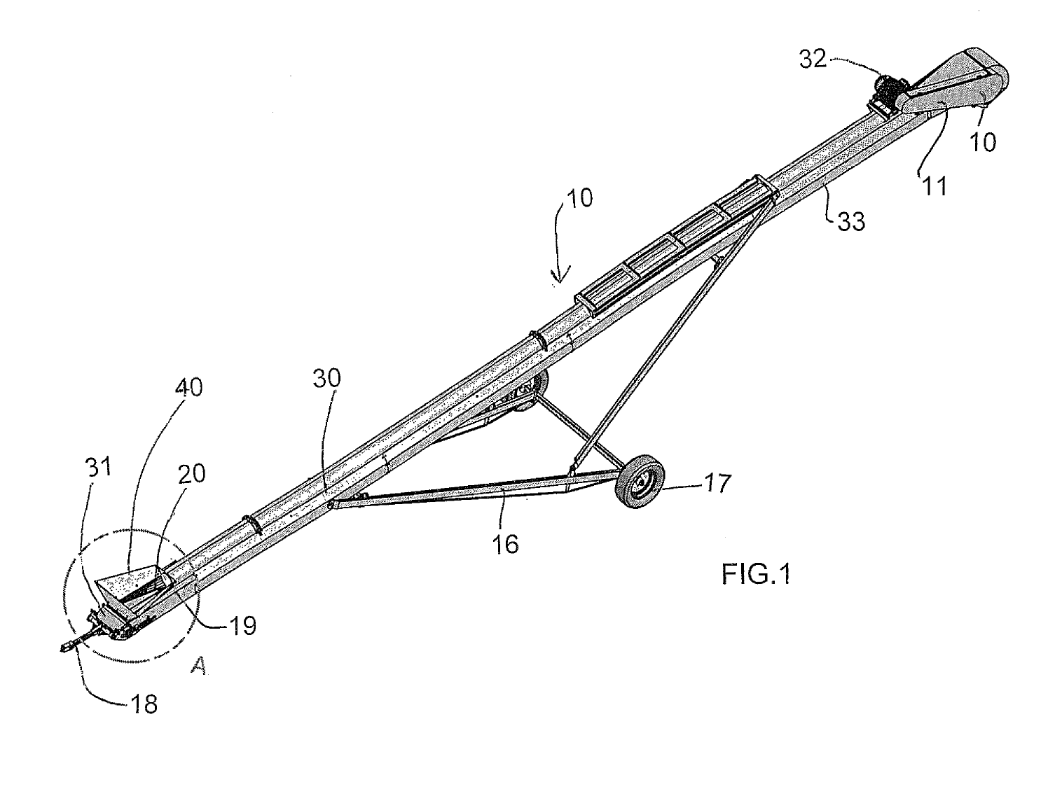

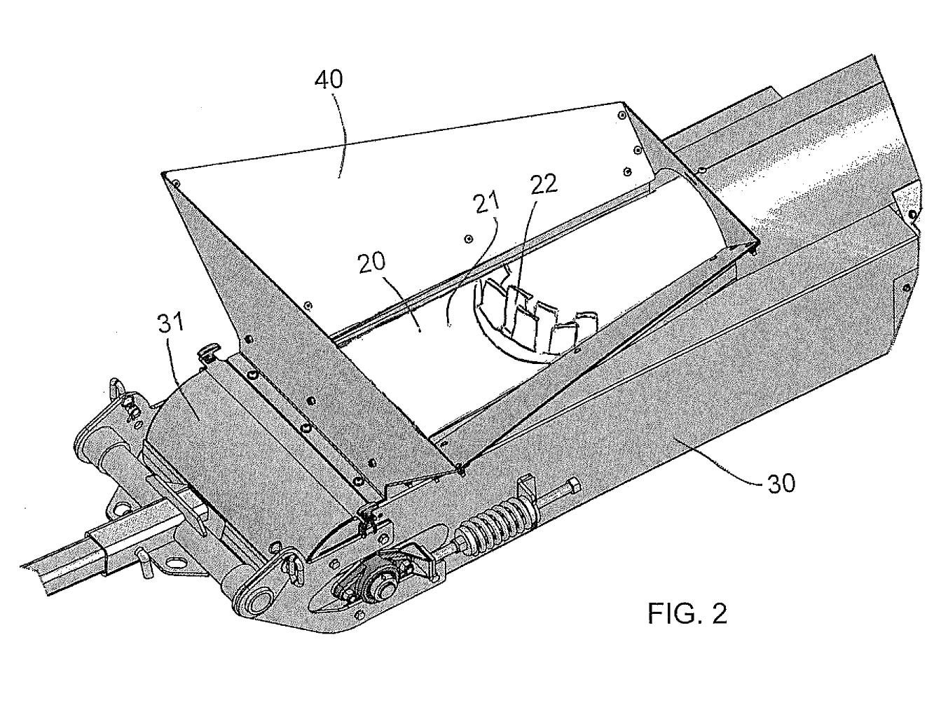

FIGS. 1 and 2 illustrate a conveyor system 10, which comprises a support frame 16, a tube 30 attached to the support frame 16, a hopper 40 attached to the intake end of the tube 30, an endless belt 20 positioned within the tube 30 and a plurality of paddle members 22 attached to the outer surface of the endless belt 20. The endless belt 20 has a generally flat structure when positioned upon the a drive roller 31 and transitions to a curved structure when entering the tube 30.

As shown in FIG. 1 of the drawings, the elongate tube 30 is supported by the support frame 16. The support frame 16 may be comprised of any well-known structure commonly utilized for supporting a belt conveyor or auger. The support frame 16 preferably includes a plurality of wheels 17 for movement over the ground, however it can be appreciated that stationary embodiments of the present invention may exist that do not utilize wheels 17. The support frame 16 also preferably includes a hitch 18 for allowing transporting of the present invention from one location to another. It can be appreciated that a hitch is not required for the present invention and that various other embodiments of the support frame 16 may be utilized.

As shown in FIG. 1 of the drawings, the tube 30 is an elongate structure having a cylindrical shape. The tube 30 may be comprised of one or more sections secured to one another. The tube 30 may have any length and diameter depending upon the use desired.

The tube 30 includes an intake end 19 and a discharge end 11 for dispersing the material transported within the tube 30. The intake end 19 of the tube 30 receives the particulate material at the hopper 40 and the discharge end 11 dispenses the particulate material. A spout 10 or other structure may be attached to the discharge end 19 as shown in FIG. 1 of the drawings.

The tube 30 preferably has a circular cross sectional area that is capable of slidably receiving the endless belt 20. It can be appreciated that the tube 30 may be comprised of various other cross sectional area shapes such as oval or elliptical. The lower portion of the tube 30 may be comprised of various other shapes for receiving and cupping the endless belt 20 during operation.

The hopper 40 is attached to the intake end of the tube 30. The hopper 40 may have various lengths, structures and shapes and may have a flat inner surface for allowing the endless belt 20 to remain within a flat state. However, preferably the bottom surface of the hopper 40 is curved to match the curvature of the tube 30. A funnel 50 is provided at the hopper 40 to guide particulate material into the intake end during operation.

The first roller 31 is attached to the lower end of the belt and a second upper roller 32 is located at the distal end portion of belt at the top end of the tube 30 for rotatably supporting one end of the endless belt 20. The second roller 32 is attached to the discharge end 11 of the tube 30 for rotatably supporting the endless belt 20 opposite of the first roller 31. The endless belt 20 passes from the flat surface of bottom roller 31 through the tube 30 about the second roller 32 along the outside of the tube 30 and about the first roller 31 back into the tube 30 transporting material from the intake end of the tube 30 out through the discharge end 36. The return run of the belt on the outside of the tube can be exposed or contained in a housing on 33 the bottom of the tube 30.

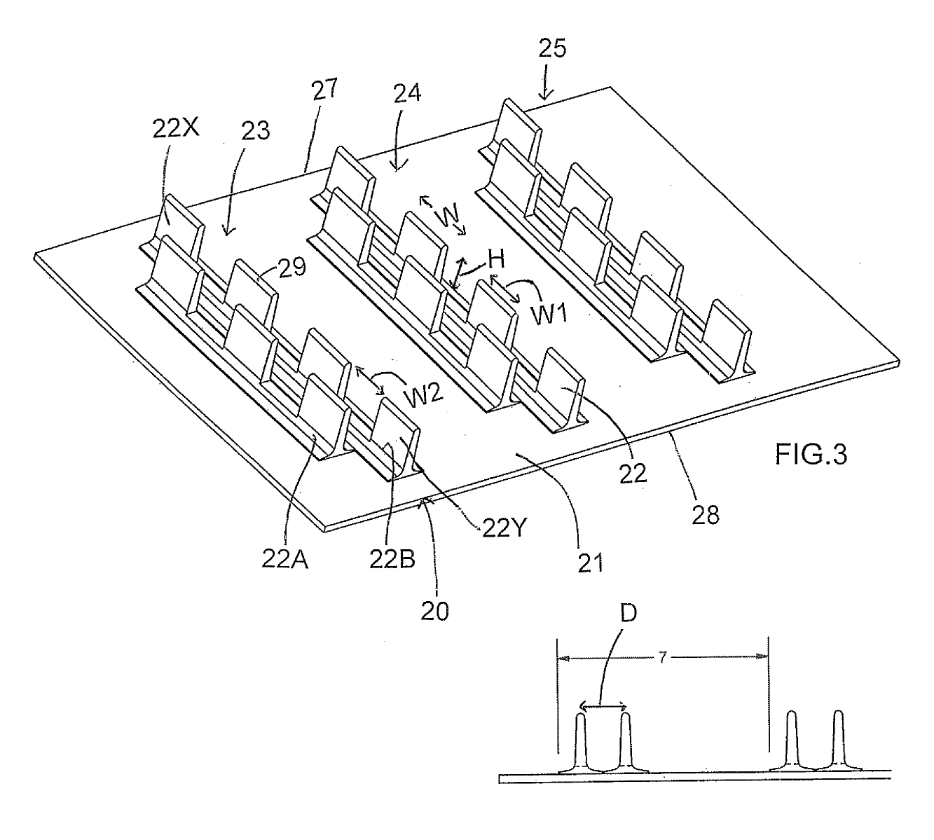

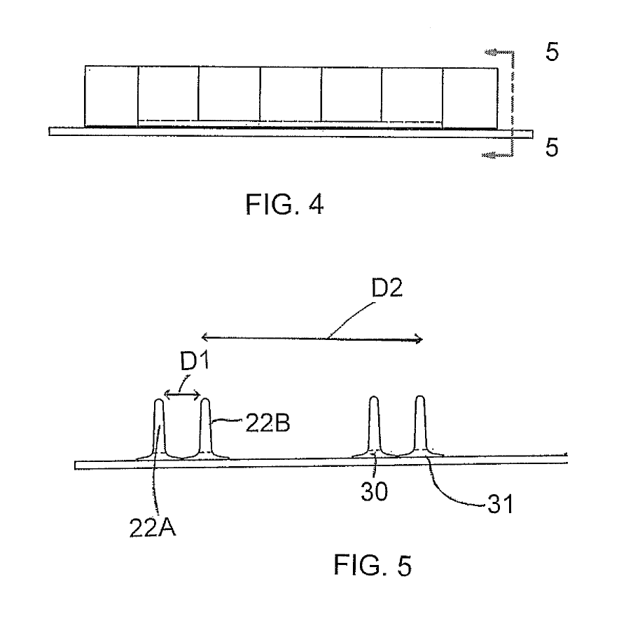

As shown in FIGS. 2 to 5, the belt has an upper surface 21 for carrying a particulate material thereon and the upper surface is flat over the rollers and concave in the curved configuration as it passes through the tube.

The upper surface 21 carries a plurality of paddle members 22 mounted on and projecting upwardly from the upper surface for restricting back flow under gravity of the particulate material on the upper surface.

The paddle members are arranged in rows of adjacent paddle members, for example a row 22A and a row 22B. The row 22B includes four paddles and the row 22A includes three paddles. The paddle members of the row 22A and the row 22B are spaced longitudinally of the belt by a distance D1 so as to avoid contact between the paddles members of the pair in either the flat configuration or as the paddle members are moved inwardly as the belt curves into the curved configuration. That is, one is located in front of the other so that there is no possibility of interference.

The distance D1 between the paddle members of the pair is however selected such that the particulate material is inhibited from back flowing between the paddle members under gravity at least in the curved configuration.

The paddle members are arranged in groups 23, 24, 25 along the belt. Each group is spaced longitudinally of the belt from the next adjacent group such that adjacent paddle members of the group are spaced longitudinally of the belt by the distance D2. This distance is of course sufficient to avoid contact between the adjacent paddles members of the group in either the flat configuration or as they move to the curved configuration. In addition the spacing between groups is arranged to reduce the number of the groups so that they are reduced to a lower number for cost reduction and for weight reduction. Typically the space therefore between each group and the next group is of the order of 6 inches. Thus the number of groups along the belt is selected so as to be as small a number as can be acceptable to provide the required restriction to back flow of the material on the belt in the inclined portion of the belt. This number may vary depending on the flow characteristics of the material to be transported.

The paddle members are arranged to be relatively high in comparison with prior art members of this general type and they are allowed to be so due to the offset configuration described above. Thus they can have a height H of at least 1.0 inches, or at least 1.5 inches and typically they are of the order of 2.0 inches.

At least some of the paddle members and typically all of them are shaped so that they are rectangular with sides 25 and 26 parallel and at right angles to the top surface of the belt. They are spaced transversely by a distance W2 which is approximately equal to or slightly less than the width W1 of the paddles. In an alternative, not shown, the width W of each paddle across the belt increases in relation to the height H from the belt with their side edges 25 and 26 inclined upwardly and outwardly from the upper surface 21 typically at an angle of the order of 75 degrees.

The paddle members 22X and 22Y of the row 22B which are closest to side edges 27 and 28 of the belt are spaced inwardly from the side edges by a distance approximately equal to the width of a paddle member. The three paddle members in the row 22A are arranged so as to be offset from the paddle members in the row 22B so that they are aligned with the three spaces between the paddle members of the row 22B.

Each group 22B contains typically four paddle members although this number may be increased for a wider belt. The group containing four paddle members can be in advance of or behind the group containing three paddle members. The group is injection molded as a in integral item from rubber or similar material with a base 30 which forms a flat bottom surface which is attached to the upper surface of the belt using a typical vulcanization process. From the flat bottom 31, the base tapers upwardly and inwardly to the bottom of the paddle members. The width of the base is sufficient to provide effective attachment to the belt. The groups are arranged such that the base of one touches the base of the next and this defines the spacing D1. The paddles themselves are slightly tapered upwardly and inwardly to the top edge both in the width and length directions to allow ready removal from the mold.

Typically the longitudinal spacing D1 between adjacent pairs is at least 1 inch and preferably 2 inches. This spacing is typically suitable to stop backflow of particulate materials in combination with the above spacing between the paddle members by which they overlap when viewed from the rear as shown in FIG. 5.

Typically the longitudinal spacing F between groups is at least 6 inches and preferably 9 inches. This separates the paddle members into individual groups so that each group operates in effect as a single cleat.

Each paddle member thus comprises a substantially flat plate which stands outwardly from the upper surface at right angles to the upper surface with the base 30 attached to the upper surface and curves inwardly and upwardly to the flat plate.

The belt as shown has the advantages that it does not in any way squeeze or pinch the product to cause a crushing effect and also the design allows use of a higher cleat design, that is, the paddle members can have a greater height in view of the longitudinal offset which avoids any possible interaction between the paddle members.

Thus the paddle members cooperate in an arrangement where two paddle members of the front row define between them a space which is sufficient to allow the paddle members to lie side by side and to avoid contact when moved into the curved configuration and a third paddle member of the rear row is positioned behind the space between the two paddle members of the front row with a width of the third paddle member which co-operates with the distance between the front row and the rear row to prevent flow or material between the front two paddle members from moving rearwardly beyond the third paddle member.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A conveyor comprising:
an endless belt arranged to travel from a first end of a conveyor path to a second end of the conveyor path;
a guide construction for the belt arranged such that the belt lies in a substantially flat configuration in a transverse plane for a part of its path and lies in a transversely curved configuration in another part of its path;
the guide construction including a duct through which the belt passes while in its curved configuration;
a drive arrangement for driving the belt along the path;
the belt having an upper surface for carrying a particulate material thereon so that the upper surface is concave in the curved configuration;
and a plurality of paddle members mounted on and projecting upwardly from the upper surface for restricting back flow under gravity of the particulate material on the upper surface;
the paddle members being arranged to cooperate in an arrangement where two paddle members of a front row define between them a space which is sufficient to allow the paddle members to lie side by side and to avoid contact when moved into the curved configuration and a third paddle member is positioned behind the space between the two paddle members of the front row with a width of the third paddle member which cooperates with the distance between the front paddle members and the third paddle to prevent flow or material between the front two paddle members from moving rearwardly beyond the third paddle member.

2. The conveyor according to claim 1 wherein the two paddle members are arranged in a front row containing a plurality of paddle members.

3. The conveyor according to claim 2 wherein the third paddle member is arranged in a rear row containing a plurality of paddle members.

4. The conveyor according to claim 3 wherein the rows are spaced longitudinally of the belt and the paddle members of each row are arranged such that adjacent paddle members of the row are spaced longitudinally of the belt by a distance so as to avoid contact between the adjacent paddles members of the row in either the flat configuration or the curved configuration.

5. The conveyor according to claim 1 wherein the distance between the paddle members of the front row is such that the particulate material is inhibited from back flowing between the paddle members of the rear row under gravity at least in the curved configuration.

6. The conveyor according to claim 1 wherein the paddle members have a height of at least 1.0 inches.

7. The conveyor according to claim 1 wherein the paddle members have a height of at least 1.5 inches.

8. The conveyor according to claim 1 wherein the paddle members have a height of at least 2.0 inches.

9. The conveyor according to claim 1 wherein the paddle members which are closest to side edges of the belt are spaced inwardly from the side edges.

10. The conveyor according to claim 1 wherein the paddle members are arranged in a row which contains at least three paddle members.

11. The conveyor according to claim 1 wherein the paddle members are arranged in two rows with one row containing one more paddle member than the other row.

12. The conveyor according to claim 12 wherein one row contains four paddle members and the other row contains three paddle members.

13. The conveyor according to claim 1 wherein the longitudinal spacing between the two paddle members of the first row and the third paddle member is at least 1 inch.

14. The conveyor according to claim 1 wherein the longitudinal spacing between the two paddle members of the first row and the third paddle member is at least 2 inches.

15. The conveyor according to claim 1 wherein the two paddle members and the third paddle member form a first group and a longitudinal spacing between the first group and a next adjacent group is at least 6 inches.

16. The conveyor according to claim 1 wherein the two paddle members and the third paddle member form a first group and a longitudinal spacing between the first group and a next adjacent group is at least 9 inches.

17. The conveyor according to claim 1 wherein each paddle member comprises a substantially flat plate which stands outwardly from the upper surface of the belt.

18. The conveyor according to claim 1 wherein each paddle member is substantially at right angles to the upper surface of the belt.

19. The conveyor according to claim 1 wherein each paddle member includes a base with a flat bottom surface attached to the upper surface and an upper surface which converges inwardly and upwardly to the paddle members.
